(19) United States
(12) Patent Application Publication
(10) Pub. No.: US 2006/0062302 A1
(43) Pub. Date: Mar. 23, 2006

(54) Fast mode decision making for interframe encoding

(76) Inventors: Peng Yin, Plainsboro, NJ (US); Jill MacDonald Boyce, Manalapan, NJ (US)

Correspondence Address: THOMSON LICENSING INC., PATENT OPERATIONS, PO BOX 5312, PRINCETON, NJ, 08543-5312, US

(21) Appl. No.: 10/541,858

(22) PCT Filed: Oct. 24, 2003
(86) PCT No.: PCT/US03/33923

§ 371 Date: Jul. 11, 2005

Related U.S. Application Data
(60) Provisional application No. 60/439,296, filed on Jan. 10, 2003.

(51) Int. Cl. H04N 11/02; H04N 7/12; H04N 11/04; H04B 1/66

(52) U.S. Cl. 375/240.16; 375/240.24; 375/240.12

(57) ABSTRACT

An encoder achieves improved encoding efficiency by initially limiting consideration of the potential modes (block sizes) to a prescribed sub-set and by performing mode estimation jointly with mode decision-making. An initial sub-set of modes is considered and an estimation of the motion for each block in the sub-set is made to establish a best motion vector. A distortion measure is also made for each sub-set. From the distortion measure, a determination is made whether or not to estimate the motion for other block sizes. If not, then an encoding mode is chosen in accordance with the estimated motion. In this way, motion estimation on all possible block sizes need not be undertaken.

### CROSS REFERENCE TO RELATED APPLICATION

This application claims priority under 35 U.S.C. 119(e) to U.S. Provisional Patent Application Ser. No. 60/439,296, filed Jan. 10, 2003, the teachings of which are incorporated herein.

### TECHNICAL FIELD

This invention relates to a technique for reducing the computational complexity of video encoding while maintaining video compression efficiency.

### BACKGROUND ART

Various techniques currently exist for compressing (encoding) a video stream to facilitate storage and transmission. Many well known encoding techniques rely both on spatial and temporal similarities. The proposed H.264 coding technique (also known as JVT and MPEG AVC) specifies inter and intra coding for interframes (P and B frames). Each individual macroblock can undergo intra coding, i.e. using spatial correlation, or inter coding using temporal correlation from previously coded frames. Generally, an encoder makes an inter/intra coding decision for each macroblock based on coding efficiency and subjective quality considerations. Macroblocks well predicted from previous frames typically undergo inter coding while macroblocks not well predicted from previous frames, and macroblocks with low spatial activity typically undergo intra coding.

The proposed JVT/ITU H.264 coding technique allows various block partitions of a 16×16 macroblock for inter coding. In particular the proposed H.264 coding technique allows for 16×16, 16×8, 8×16, and 8×8 partitions of a 16×16 macroblock, and 8×8, 8×4, 4×8, 4×4 partitions of an 8×8 sub-macroblock, as well as multiple reference pictures. Furthermore, the proposed H.264 coding technique also supports skip and intra modes. There exist two types of Intra modes: 4×4 and 16×16, hereinafter referred to as INTRA_{—}4×4 and INTRA_{—}16×16. The INTRA_{—}4×4 mode supports 9 prediction modes whereas; the INTRA_{—}16×16 mode supports 4 prediction modes. All these choices have greatly increased the complexity associated with making a mode decision in a timely manner.

Thus, a need exists for a technique that simplifies mode decision-making.

### BRIEF SUMMARY OF THE INVENTION

Briefly, in accordance with a preferred embodiment, there is provided a method for encoding a macroblock capable of being partitioned into a plurality of different block sizes. Initially, a sub-set of block sizes is selected. The motion of an image associated with each block size in the sub-set is estimated to establish a best motion vector. For each block size, a distortion measure is established. Based on the distortion measure, a determination is made whether motion estimation should occur for block sizes not within the sub-set. If not, then an encoder selects an encoding mode for encoding the macroblock in accordance the estimated motion of the selected sub-set of block sizes.

### BRIEF DESCRIPTION OF THE DRAWINGS

FIG. 1 depicts a block schematic diagram of a conventional encoder for encoding video in accordance with the JVT compression standard;

FIG. 2 illustrates in flow chart form a method in accordance with the present principles for making a mode decision for inter frame encoding; and

FIG. 3 illustrates in flow chart form a method in accordance with the present principles for making a mode decision for intra frame encoding.

### DETAILED DESCRIPTION

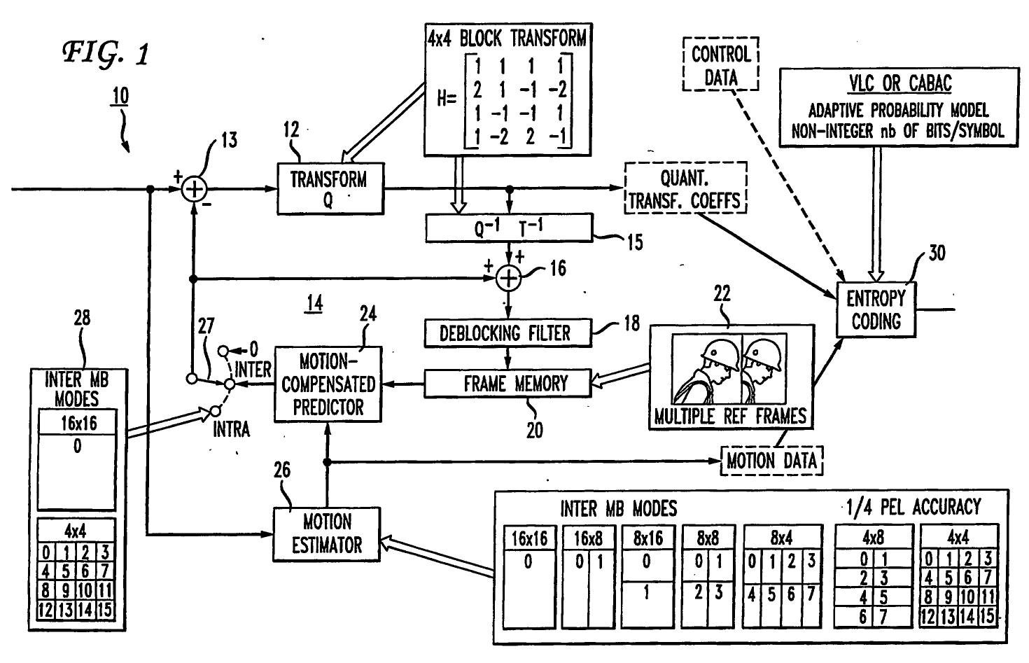

In order to better appreciate the encoding method of the present principles, refer to FIG. 1, which depicts a block diagram of the architecture of a typical JVT encoder 10 for encoding an incoming video stream. The encoder 10 includes a first block 12 that receives the output of a difference block 13 supplied at its positive input with the incoming video frames from a video source (not shown). The block 12 quantizes each video frame received from the difference block 13 and then performs a block transformation to yield a quantized frame together with a corresponding set of transformation coefficients.

A loop 14 feeds back each quantized frame and the corresponding transformation coefficients output by the block 12 to enable the formation of prediction frames (P or B frames). The loop 14 includes a block 15 that performs inverse quantization and inverse transformation of the quantized frames and transformation coefficients, respectively, from the block 12 for receipt at a first input of a summation block 16 whose output is coupled to a deblocking filter 18. The deblocking filter 18 deblocks each video frame received from summation block 16. Such filtered frames undergo storage in a frame memory 20, thus creating a store of multiple reference frames 22. Using the reference frames 22 stored in the frame memory 20, a predictor block 24 generates a reconstructed prediction frame that is motion compensated in accordance with a motion vector generated by a motion estimation block 26.

The JVT video coding standard permits both inter coding and intra coding of P and B frames. To effect inter coding, the difference block 13 has its negative output coupled via a selector 27 to the motion compensator block 24. In this manner, the difference block 13 will subtract one or more motion compensated reference frames 22 from each incoming video frame. The selector 27 effects intra-coding by coupling the negative input of the difference block 13 to an intra mode block 28 that provides an intra-coded reference frame. The JVT video coding standard supports two block types (sizes) for intra coding: 4×4 and 16×16. The 4×4 block size supports 9 prediction modes: vertical, horizontal, DC, diagonal down/left, diagonal down/right, vertical-left, horizontal-down, vertical-right and horizontal-up prediction. The 16×16 block size supports 4 prediction modes: vertical, horizontal, DC and plane prediction. The selector 27 effects a null mode at which the negative input of the difference block neither receives the reconstructed frame from the motion compensated predictor block 24 nor the output of the intra mode block 28. In this mode, the block 12 receives an incoming video frame with no subtractions.

The encoder 10 of FIG. 1 includes an entropy-coding block 30, which combines the quantized frame and transform coefficients from the block 12 together with motion data from the motion estimator 26 and control data, to yield an encoded video frame. Each encoded frame produced at the output of the entropy-encoding block 30 passes to a Network Abstraction Layer (NAL) (not shown) for storage and/or subsequent transmission. The entropy encoder 30 can make use of either Variable Length Coding (VLC) or Context-based Adaptive Binary Arithmetic Coding (CABAC).

The proposed H.264 coding technique uses tree-structured hierarchical macroblock partitions. Inter-coded 16×16 pixel macroblocks can undergo partitioning into macroblock sizes of: 16×8, 8×16, or 8×8. Macroblock partitions of 8×8 pixels, known as sub-macroblocks, can also exist. Sub-macroblocks can undergo partitioning into sub-macroblocks of size 8×4, 4×8, and 4×4. The encoder 10 typically selects how to divide the macroblock into partitions and sub-macroblock partitions based on the characteristics of a particular macroblock in order to maximize compression efficiency and subjective quality.

As described, the encoder 10 can make use of multiple reference pictures for inter-prediction. In this regard, a reference picture index identifies the particular reference picture. P pictures (or P slices) make use of a single directional prediction and a single list (list 0) that manages the allowable reference pictures. Two lists of reference pictures, designated as list 0 and list 1, serve to manage the two sets of reference pictures for B pictures (or B slices). The JVT video coding standard allows a single directional prediction using either list 0 or list 1 for B pictures (or B slices). When bi-prediction is used, the list 0 and the list 1 predictors are averaged together to form a final predictor. Each macroblock partition can have independent reference picture indices, prediction type (list 0, list 1, bipred), and an independent motion vector. Each sub-macroblock partition can have independent motion vectors, but all sub-macroblock partitions in the same sub-macroblock use the same reference picture index and prediction type.

For inter-coded macroblocks, a P frame can also support a SKIP mode besides the above described macroblock partition, whereas B frames can supports both SKIP and DIRECT modes. In the SKIP mode, no motion and residue information encoding occurs. The motion vector remains the same as the motion vector predictor. In the DIRECT.mode, no motion information is encoded, but the prediction residue is encoded. The motion vector is inferred from spatial or temporal neighboring macroblocks. Both macroblocks and sub-macroblocks support the DIRECT mode.

In the past, JVT encoders, such as the encoder 10 of FIG. 1, have made use of a Rate-Distortion Optimization (RDO) framework for making a decision whether to encode using either the intra mode or the inter mode. For inter mode encoding, the encoder considers motion estimation separately from the mode decision. Motion estimation occurs first for all block types, then the encoder makes a mode decision by comparing the cost (a combination of rate and distortion) for coding each block using the inter mode and the intra mode. The encoder chooses the mode with the minimal cost as the best mode. Given the large number of possible block sizes, selecting the coding mode in this manner consumes significant resources.

The coding technique of the present principles alleviates much of the complication associated with mode decision making for coding interframes. The present technique reduces the number of block sizes for possible consideration and restricts the set of past coded reference pictures for motion estimation. In this way, motion estimation for some block types and reference pictures becomes unnecessary. The present technique also decreases the number of tested intra modes.

To simplify the explanation of the present mode selection technique, the modes will be divided into two categories: inter modes and intra modes. For discussion purposes inter modes include the SKIP mode (and the DIRECT mode for B pictures) and different block sizes, including 16×16, 16×8, 8×16, 8×8, 8×4, 4×8, 4×4). Intra modes include the INTRA 4×4 mode and the INTRA 16×16 mode. P pictures best serve to illustrate the present technique, although the technique has applicability to B pictures as well. For B pictures, the SKIP mode and the DIRECT mode are treated in the same way, and, the DIRECT mode also takes into consideration the sub macroblock for selecting the best mode.

The present mode selection technique undertakes motion estimation jointly with mode decision-making. Motion estimation occurs for a particular inter mode upon its selection. For inter modes, the SKIP mode does not require a motion search, and thus has the lowest computational complexity. In accordance with the present principles, the SKIP mode remains separate and receives the highest priority by virtue of its low complexity. As for mode decision-making on block sizes, the technique of the present principles compares whether the ratio between a distortion (error) measure and the block size is monotonic. The ratio, hereinafter referred to as the error surface, provides a measure of whether the distortion continues to decrease with a decrease in block size.

Initially, an error surface computation occurs only for each of three initial block sizes: 16×16, 8×8, and 4×4. In this context, the term “8×8” implies examination of the entire macroblock using only 8×8 partitions, whereas the term “4×4” implies examination of the entire macroblock using only 4×4 partitions. The error surface has the property of being monotonic if J(16×16)<J(8×8)<J(4×4) or J(16×16)>J(8×8)>J(4×4), where the operator J represents the error surface operator. The error surface calculation for the 16×16, 8×8 and 4×4 block sizes will determine whether to test other modes, such as the 16×8, 8×16, or finer sub-macroblock partitions. In the absence of a monotonic error surface, all other block sizes must undergo testing. If the surface is monotonic, block sizes between the best two block sizes require further testing.

For example, if the two best block sizes are 16×16 and 8×8, which implies that the macroblock tend to use larger block partitions, only the 16×8 and 8×16 block sizes require further testing. Conversely, if the best two block sizes are 8×8 and 4×4, this implies that the macroblock is better predicted by means of smaller block partitions (or sub-macroblock partitions), and only 8×4 and 4×8 block sizes require further testing.

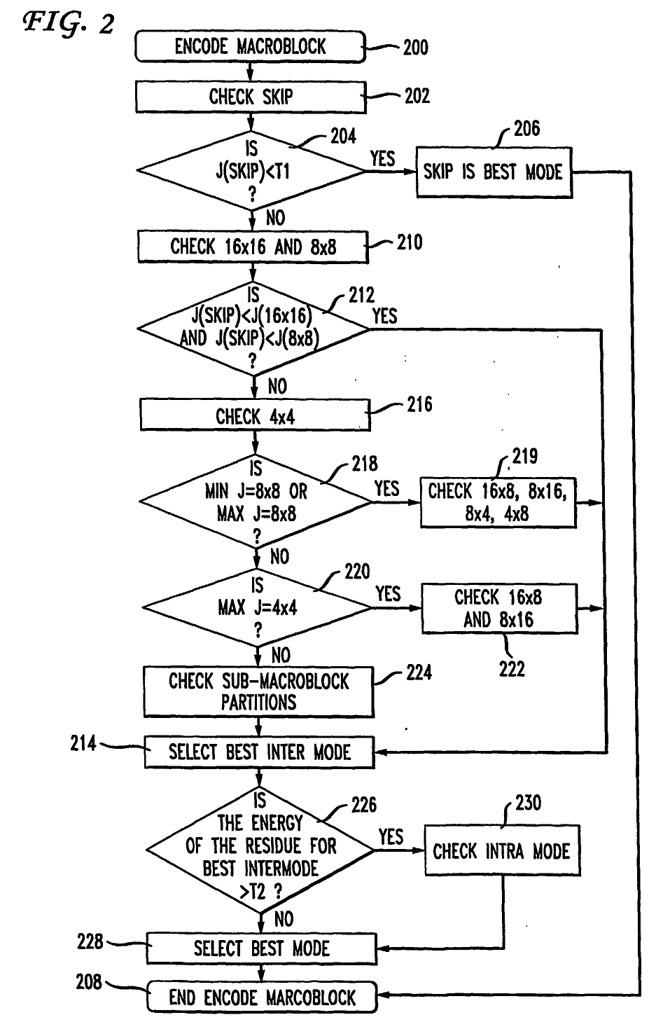

FIG. 2 depicts in flow chart form the steps of a method in accordance with present principles for making a mode decision for inter frame coding. The method commences upon execution of step 200, whereupon various elements within the encoder 10 are reset. Next, during step 202, an error surface calculation for the SKIP mode occurs. During step 204, a determination is made whether the error surface for the SKIP mode is less than a first threshold value T1. If so, then the SKIP mode constitutes the best mode for inter frame encoding, and selection of the SKIP mode occurs during step 206. Thereafter, macroblock encoding ends upon execution of step 208.

Should the SKIP mode error surface equal or exceed T1 during step 204, then the error surface for each of the 16×16 and 8×8 block sizes is established during step 210. During step 212, a determination occurs whether J(SKIP)<J(16×16) and J(SKIP)<J(8×8). Should J(SKIP)<J(16×16) and J(SKIP)<J(8×8), then step 214 occurs, and the best inter mode is selected, taking into account the coding cost of the motion vector, the mode itself, and the remaining residual. Otherwise, when the condition J(SKIP)<J(16×16) and J(SKIP)<J(8×8) isn't true, then step 216 occurs and a calculation is made of the error surface of the 4×4 mode. The comparison of the cost of the SKIP mode with that of the block sizes 16×16 and 8×8 is predicated on the assumption that if the RD cost for SKIP mode is the minimal, then the probability for other block types to have a lower cost than SKIP mode will be very small, so no need exists to check the other inter modes.

Following step 216, a check is made whether MinJ=J(8×8) or MaxJ=J(8×8) during step 218. If so, a determination of the error surfaces of each of the 16×8, 8×16, 8×4 and 4×8 block sizes occurs during step 219 before proceeding to step 214. Otherwise, if the condition MinJ=J(8×8)∥MaxJ=J(8×8) isn't true, step 220 occurs and a check occurs to determine whether MaxJ=J(4×4) is true. If true, then a determination is made of the error surface of the 16×8 and 8×16 block sizes during step 222 before proceeding to step 214. When performing steps 224 and 222, not all reference pictures need to be checked. Empirical statistics show that 8×4 and 4×8 block sizes only need to be checked within the best reference picture of the 8×8 and 4×4 mode block sizes, while 16×8 and 8×16 modes block sizes need to be checked within the best reference picture of the 8×8 and 16×16 mode block sizes.

The comparisons made during steps 218 and 220 reveal whether the error surface is monotonic which if true, obviates the need for the encoder 10 of FIG. 1 to perform the error surface calculations made during step 219. Thus, the comparisons made during steps 218 and step 220 serve to narrow the sub-set of block sizes for which error surface measurements occur, thus reducing encoder computational effort.

If MaxJ=J(4×4) isn't true when checked during step 220, step 224 occurs, whereupon a calculation is made of the error surfaces of the sub macroblock partitions not otherwise calculated, before proceeding to step 214. Thus, during step 224 an additional decision process occurs for each 8×8 block size to decide which type shall be used among the 4 sub-macroblock partitions. Only 8×4 and 4×8 need undergo testing. The initial result of 8×8 and 4×4 can be reused. Thereafter, a check occurs during 226 whether the energy of the residue for best inter mode is exceeds a second threshold T2. If not, then selection of the best mode occurs during step 228 in accordance with the best inter mode previously selected during step 214, before proceeding to step 208. (This presumes that inter modes always have higher priority than intra modes for inter images.)

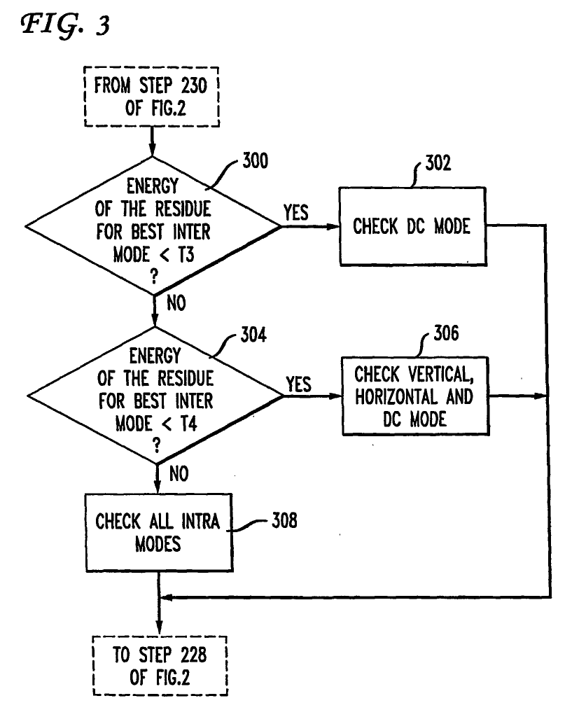

Should the energy of the residue for the best inter mode exceed T2 during step 226, then step 230 occurs during which a check is made for the best intra mode, as best described with respect to FIG. 3, before proceeding to step 228. The performance of inter modes is measured by the energy (squared magnitude) of the residue, which constitutes the difference between the original signal and a reference signal. The residue can be simply computed from the sum of the absolute value of the block transform coefficients, or the number of block transform coefficients in the current macroblock.

FIG. 3 depicts the steps associated with Intra mode decision making that occur during execution of step 230 of FIG. 2. As seen in FIG. 3, inter mode checking commences upon execution of step 300 during which a determination occurs whether the energy of the best inter mode exceeds a third threshold T3. If not, a calculation of the error surface of the DC mode occurs during step 302 before proceeding to step 228 of FIG. 2. Should the energy of the best inter mode exceeds a third threshold T3 during step 300, a comparison occurs during step 304 whether the energy of the best inter mode exceeds a fourth threshold T4. If not, then the error surface is established for the vertical, horizontal and DC modes during step 306 before proceeding to step 228 of FIG. 2. Otherwise, a check is made of the error surface of all intra modes during step 308 before proceeding to step 228 of FIG. 2.

The foregoing describes a technique for reducing video encoding computational complexity by reducing the amount effort in connection with inter frame and intra frame coding decisions.

1. A method for encoding a macroblock capable of being partitioned into a plurality of different block sizes, comprising the steps of:
(a) selecting a sub-set of block sizes;
(b) estimating motion of an image represented by data associated with each block size in the sub-set to establish a best motion vector for said each block size;
(c) establishing a distortion measure for each block size in the sub-set;
(d) determining from the distortion measure whether motion estimation should be undertaken on block sizes not within the sub-set, but if not, then
(e) choosing an encoding mode for encoding the macroblock in accordance the estimated motion.

2. The method according to claim 1 wherein the step of selecting from a sub-set of block sizes comprises the step of selecting the sub-sizes 16×16, 8×8 and 4×4 for a 16×16 macroblock encoded using JVT encoding.

3. The method according to claim 2 wherein said determining step comprises the step of undertaking motion estimation for 16×8, 8×16, 8×4 and 4×8 block sizes.

4. The method according to claim 1 further comprising the step of performing motion estimation for other block sizes only for a limited set of reference pictures, based upon a set of best reference pictures chosen for the selected subset of block sizes

5. The method according to claim 1 further comprising the step of determining whether an error block surface is classified as monotonic or non-monotonic based on relative values of the distortion measures.

6. The method according to claim 1 wherein the step of choosing the encoding mode comprises the step of choosing one of an inter mode and an intra mode.

7. The method according to claim 6 wherein the determining step further comprises the step of checking whether the inter mode has a residue exceeds a prescribed threshold.

8. The method according to claim 1 wherein the determining step comprises the step of the determining a distortion measure for a limited set of intra modes.

9. An encoder for encoding a macroblock capable of being partitioned into a plurality of different block sizes by the steps of:
(a) selecting a sub-set of block sizes;
(b) estimating motion of an image represented by data associated with each block size in the sub-set to establish a best motion vector for said each block size;
(c) establishing a distortion measure for each block size in the sub-set;
(d) determining from the distortion measure whether motion estimation should be undertaken on block sizes not within the sub-set, but if not, then
(e) choosing an encoding mode for encoding the macroblock in accordance the estimated motion.

10. The encoder according to claim 9 wherein the encoder selects from the sub-set of block sizes by selecting the sub-sizes 16×16, 8×8 and 4×4 for a 16×16 macroblock encoded using JVT encoding.

11. The encoder according to claim 9 wherein the encoder undertakes motion estimation for 16×8, 8×16, 8×4 and 4×8 block sizes.

12. The encoder according to claim 9 wherein the encoder performs motion estimation for other block sizes only for a limited set of reference pictures, based upon a set of best reference pictures chosen for the selected subset of block sizes

13. The encoder according to claim 9 wherein the encoder determines whether an error block surface is classified as monotonic or non-monotonic based on relative values of the distortion measures.

14. The encoder according to claim 9 wherein the encoder chooses the encoding mode from one of an inter mode and an intra mode.

15. The encoder according to claim 14 wherein the encoder checks whether the inter mode has a residue exceeds a prescribed threshold.

16. The encoder according to claim 15 wherein the encoder determines a distortion measure for a limited set of intra modes.
